(19) United States
(12) Patent Application Publication
(10) Pub. No.: US 2018/0018630 A1
(43) Pub. Date: Jan. 18, 2018

(54) Online Assessment Systems And Methods

(71) Applicant: Adeboyejo Adetokunbo Oni, Bethesda, MD (US)

(72) Inventor: Adeboyejo Adetokunbo Oni, Bethesda, MD (US)

(21) Appl. No.: 15/209,725

(22) Filed: Jul. 13, 2016

(51) Int. Cl. G06Q 10/10; G06Q 50/20

(52) U.S. Cl. CPC G06Q 10/105; G06Q 50/2057

(57) ABSTRACT

Online career, educational and occupational assessments are provided for individuals. The assessments include the ability to map a Holland code to academic majors and occupations and further apply confidence and work value filters to identify potential majors and occupations that may best match an individual's interests and desires.

### RELATED APPLICATIONS

This application is related to U.S. patent application Ser. No. 15/081,290 filed Mar. 25, 2016 (the “'290 Application”), U.S. patent application Ser. No. 14/883,424 (the “'424 Application”) filed Oct. 14, 2015 and U.S. patent application Ser. No. 10/657,562 (the “'562 Application”) now U.S. Pat. No. 7,299,217 and incorporates by reference herein the entire disclosures, both text and drawings, of the '290, '424 and '562 Applications as if set forth in full herein.

### INTRODUCTION

Historically, educational, career and vocational assessment tests or evaluations have been provided as “in person” (e.g., using paper and pencil) services, or if offered online, require an individual to access different web sites offered by various different companies if the individual wishes to complete different assessments, compare one assessment with another or obtain the results or evaluations of these tests. Further, in general the assessment results have not further assisted the individual in identifying majors and sub-majors within broad academic areas, or in identifying information that matches attributes of a particular individual, among other things.

Accordingly, it is desirable to provide a plurality of online assessment systems and methods that overcome the disadvantages of existing assessment products and services.

It is further desirable to provide improvements over existing assessment products and services by, for example, providing novel and non-obvious mapping of an individual's assessment data to identify majors, occupations, academic institutions, vocational institutions or potential employers of particular interest to the individual.

### SUMMARY

In accordance with the present invention, online career, educational and occupational assessments are provided for individuals. The assessments include the ability to map assessment results to academic majors and occupations and further apply confidence and work value filters to identify potential majors and occupations that may best match an individual's interests and desires. Accordingly, the inventive assessments provide a user (e.g., student) with an improved ability to identify majors, occupations and vocations that best match his or her interests and desires, among other novel and non-obvious improvements.

In one embodiment, a system for providing online assessments may comprise a network, hardware platform (e.g., one or more hardware servers) operable to (i) receive current or historical user assessment data, over a communications network (e.g., wired or wireless network); (ii) identify one or more reference academic majors or occupations that best matches the user assessment data, as well as identify one or more academic institutions, vocational institutions or potential employers based on the identified, reference academic majors or occupations, and (iii) transmit data representing the one or more reference academic majors or occupations, and data representing the one or more academic institutions, vocational institutions or potential employers, to the electronic device, over the communications network.

The user assessment data may comprise either current or historical user interest data (e.g., current or historical Holland code associated user data), or both, and the platform may be further operable to (iv) identify the one or more reference academic majors or occupations that best matches the received user interest data, and (v) transmit data representing the one or more identified, academic majors or occupations, over the communications network, to the electronic device.

In more detail, the platform may further operable to (vi) compare the received user interest data to a plurality of user interest reference data, and (vii) identify which reference data best matches the received user interest data based on the comparison in order to identify the one or more reference academic majors or occupations.

Still further, the platform may be operable to (viii) identify one or more reference academic majors or occupations that best matches the received Holland code associated user data, (ix) transmit data representing the one or more reference academic majors or occupations, over the communications network, to the electronic device, (x) compare received current Holland code associated user data to a plurality of Holland code reference data, where a set of the reference data is associated with the one or more reference academic majors or one or more occupations, and (xi) identify which set of reference data best matches the received current Holland code associated user data based on the comparison in order to identify a current, assessed Holland code and the one or more reference academic majors or occupations (e.g., science, technology, engineering and math (STEM) occupations, and/or science, technology, engineering, math and arts (STEAM) occupations.

The user assessment data may comprise data selected from the group consisting of STEM assessment data, science, technology, engineering, math and arts (STEAM) assessment data, personal globe inventory (PGI) assessment data, skills assessment data, aptitude assessment data, personality assessment data, work-related assessment data, and data from an assessment that has psychometric properties, for example.

In ne embodiment, the electronic device communicating with the platform may comprise a wired or wireless user device, where the user device may be operable to transmit user assessment data to the platform.

In response, in one embodiment, a platform that is part of an inventive system may be operable to transmit data representative of a result of an assessment to the electronic device over the communications network, wherein the data representative of the result may comprise data for communicating the results to the electronic device in a textual, audio, video or image format or some combination of such formats.

In addition to identifying academic majors and occupations platforms provided by the present invention may be operable to (a) receive confidence level and work expectation indicators for two or more reference academic majors, or for two or more reference occupations, over a communications network, from an electronic device, (b) generate data representing a mapping of the confidence level and work expectation indicators, and (c) transmit data representing the mapped confidence levels and work expectation indicators to the electronic device, for example.

The platform may transmit data representing at least a graphical representation of the mapped confidence level and work expectation indicators for each academic major or occupation, over the communications network, to the electronic device, or alternatively, transmit data representative of the mapped confidence level and work expectation indicators for each academic major or occupation, over the communications network, to the electronic device wherein the data representative of the mapped confidence level and work expectation indicators comprises textual, audio, video or image formatted data or a combination of such formatted data.

More generally, the platform may be operable to receive confidence level and work expectation indicators for two or more of the academic majors, or for two or more of the reference occupations, over the communications network, from the electronic device, generate data representing a mapping of the confidence level and work expectation indicators, and transmit data representing the mapped confidence levels and work expectation indicators. The data transmitted may comprise textual, audio or image format data or a combination of such formatted data.

In an additional embodiment, the platform may be operable to receive a plurality of different types of current or historical user assessment data, each type associated with a different assessment, over a communications network, from an electronic device, generate assessment results for each of the different types of user assessment data, modify one or more of the results by applying an electronic linear or non-linear weight (e.g., weights that may be based on one or more attributes of a user) to each result, combine one or more of the modified or unmodified assessment results to form a personal assessment profile, store the personal assessment profile, and transmit the personal assessment profile, over the communications network, to the electronic device.

In response, the electronic device (e.g., a wired or wireless user device) may be operable to receive the personal assessment profile from the platform, store the profile, and selectively apply the stored profile to data received from a source other than the platform to identify whether data within the so received data matches the profile.

User devices provided by the present invention may be operable to output data that matches such a profile as text, audio, video or image formatted data or as a combination of such formatted data.

A profile may comprise attributes of a user selected from the group consisting of age, nationality, employment status, health, years of education, years of employment, geographic location, gender, academic grades, academic accomplishments, skills, hobbies, vocational accomplishments, and personality properties.

In addition to the systems described above, the present invention provides for methods for providing online assessments that parallel or compliment the systems described above. For the sake of the reader, and clarity, the inventor will refrain from repeating redundant subject matter, I being understood that while the subject matter may be described in similar terms, the inventive methods are distinct from the inventive systems. The reader is referred to the claims set forth herein for a listing of some of the methods encompassed by the inventions described herein.

Though this summary is intended to summarize the embodiments described herein, it should be understood that variations of the summarized embodiments may be made without departing from the spirit of the invention.

For example, other embodiments besides those related to education, careers or vocations are encompassed by the teachings of the present invention.

### BRIEF DESCRIPTION OF THE DRAWINGS

FIG. 1 depicts a block diagram of an exemplary system according to one embodiment of the invention.

FIGS. 2A through 2J depict visuals that together form an assessment in accordance with one or more embodiments of the present invention.

### DETAILED DESCRIPTION, WITH EXAMPLES

Exemplary embodiments of systems and methods for providing online educational, career and vocational assessments are described herein. It should be understood that, although specific exemplary embodiments are discussed herein, there is no intent to limit the scope of the present invention to such embodiments. To the contrary, it should be understood that the exemplary embodiments discussed herein are for illustrative purposes, and that modified and alternative embodiments may be implemented without departing from the scope of the present invention. Said another way, the exemplary embodiments presented herein are only some of the many that fall within the scope of the present invention, it being practically impossible for the inventor to describe all of the many possible exemplary embodiments and variations that fall within the scope of the present invention.

For example, though the systems and methods described herein focus on applying the inventive systems and methods to educational, career and vocational assessments, it should be understood that this is for illustrative purposes only, it being further understood that the systems and methods may be applied to other types of assessments such as healthcare, to name just one of the many additional types of assessments that the inventive systems and methods may be applied to.

It should be understood that when the description herein describes the use of a “platform”, such a platform may include a set of compatible hardware components or devices on which software or firmware applications can be executed using stored electrical signals. For example, the components or devices may include one or more hardware servers, as well as one or more processors, memories, caches and databases that may be operating based on a LINUX operating system, for example. The servers and processors may be operable to execute stored, specialized instructions for completing associated features and functions described herein. Such instructions may be stored in an onboard memory, or in separate memory, and the servers and/or processors may access one or more memories or databases, for example. Such instructions represent functions and features that have been integrated into memory as stored, electronic signals, for example.

It should also be understood that one or more exemplary embodiments may be described as a process or method. Although a process/method may be described as sequential, it should be understood that such a process/method may be performed in parallel, concurrently or simultaneously. In addition, the order of each step within a process/method may be re-arranged. A process/method may be terminated when completed, and may also include additional steps not included in a description of the process/method.

Yet another phrase is “user device”. As used herein a user device is a device used by an individual to exchange information with systems, devices (e.g., platforms) provided by the present invention. Exemplary non-limiting examples of a user device are a wired or wireless device, a desktop computer, a laptop computer, tablet, phablet, hand-held device, terminal, a virtual machine, or server to name just a few examples, while exemplary examples of a user are a student, individual seeking a career, profession or trade or an individual seeking employment.

As used herein, the term “and/or” includes any and all combinations of one or more of the associated listed items. As used herein, the singular forms “a,” “an” and “the” are intended to include the plural form, unless the context and/or common sense indicates otherwise. It should be further understood that the terms “comprises”, “comprising,”, “includes” and/or “including”, when used herein, specify the presence of stated features, systems, subsystems, steps, operations, elements, and/or components, but do not preclude the presence or addition of one or more other features, systems, subsystems, steps, operations, elements, components, and/or combinations thereof.

When used herein the terms “identify”, “compare”, “transmit”, “receive”, “generate”, “modify”, “combine”, “store”, “output” and “input” and their many tenses are functions that may be completed by a hardware platform or user device that includes known microelectronic, electronic, mechanical, electro-mechanical, or other hardware that is modified to complete the features and functions of embodiments of the invention described herein by, for example, receiving signals from, and transmitting signals to, a processor that is a part of such a platform or user device used to control such hardware.

It should be understood that where used herein, the designations “first”, “second”, “third”, etc., is purely to distinguish one component (e.g., app, device, subsystem, section, etc.,) or part of a process from another and does not indicate an importance, priority or status. In fact, the component or parts of a process could be re-designated (i.e., re-numbered) and it would not affect the scope of the present invention.

As used herein the phrases “connection”, “connected to”, or similar phrases means an indirect or direct physical connection between at least two different parts of a device or system, or means one part of a device or system is subsumed within (and thereby connected to) at least one other part of a device or system. It should be understood that when one part of a device or system is described or depicted as being connected to another part, other components used to facilitate such a connection may not be described or depicted because such components are well known to those skilled in the art.

Yet further, when one part of a device or system is described or depicted as being connected to another part using “a connection” (or single line) in a figure it should be understood that practically speaking such a connection (line) may comprise (and many times will comprise) more than one physical connection or channel, may be omni-directional or bi-directional, and may or may not include separate data, formatting and signaling.

Still further, it should be understood that a system or device (e.g., user device) that completes features and functions of embodiments of the invention may include a web browser that is a part of an interface or one or more applications (often referred to herein as an “app” or “apps”) that have been installed into, or downloaded onto, a system or device. An “app” may include “content” (e.g., text, audio, image and video files), signaling and configuration files. For the sake of convenience and not limitation, the terms “app” or “application” are used herein to refer to any application, but use of such a term also includes a reference to any file or data.

In one embodiment, an app to be downloaded onto a user device may reside or be stored on one or more hardware devices, such as a server in whole and/or in part, the later indicating that the app may be distributed among, and by, a number of devices (servers). An app may be downloaded to a user device from an app server (or servers as the case may be) or have been otherwise provided and installed on such a device. A given user device may have a need for one or more of the apps installed on a server. Accordingly, it should be understood that each of the embodiments described herein includes protocols, necessary hardware, software and firmware resident on a user device for transmitting and receiving (i.e., “transceiving”) an app, content and/or content identification information relating to the app from/to a server (i.e., platform) and vice-versa. It should be understood that depending on the content to be transmitted, an app may be installed directly on a user device or may be downloaded from a server by initiating a request to a server to receive a local copy of the app.

It should be noted that the systems and devices, as well as any subsystems, etc., thereof, illustrated in the figures are not drawn to scale, are not representative of an actual shape or size and are not representative of any actual system, platform or device layout, or manufacture's drawing. Rather, the systems and devices are drawn so as to help explain the features, functions and processes of various exemplary embodiments of the present invention described herein.

As used herein, the term “embodiment” refers to one example of the present invention.

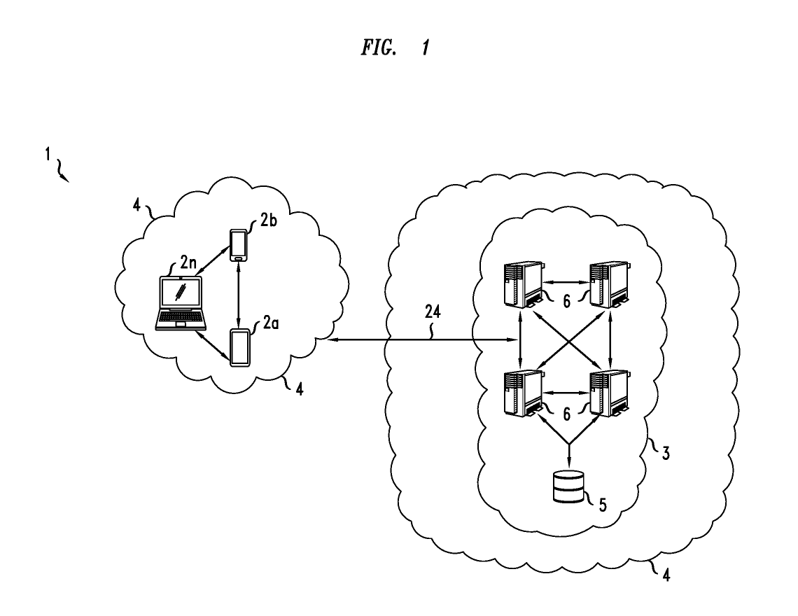

Turning now to FIG. 1, there is depicted a block diagram of an overall system 1 for completing online assessments according to one embodiment. As shown in FIG. 1, the system 1 may comprise a network hardware platform 3 (“platform” for short), and user devices 2a, 2b, . . . 2n (where “n” represents the last user device). It should be understood that other components may be included in the system 1, but these components and their respective functions are believed to be well known by those skilled in the art, and, therefore, for the sake of clarity their description will be omitted.

Each of the user devices 2a, 2b, . . . 2n (hereafter referred to as “devices”) and platform 3 may be part of a different network or may be part of the same network, such as network 4. Each of the devices 2a, 2b, . . . 2n may comprise a wired or wireless device, a desktop computer, a laptop computer, tablet, phablet, hand-held device, terminal, a virtual machine, or server to name just a few examples, operable to transmit and receive data to, and from, the platform 3. Such devices 2a, 2b, . . . 2n may be located locally or remotely from the platform 3.

In an exemplary embodiment the devices 2a, 2b, . . . 2n may comprise the necessary hardware and software for completing all of the functions and features described herein. For example, hardware for connecting them to the platform 3 and network 4 via wired or wireless means known to those skilled in the art, the use of a stored operating system such as a Windows based system, Apple iOS or Java, and one or more processors specially designed and programmed to store such an operating system and complete the features and functions described herein by, for example, by accessing integrated instructions stored in memory and/or data stored in memory.

It should be understood that a service or services provided by the platform 3 to a user device may be an “on demand”, real-time service, or, alternatively may comprise a free service, or (“freemium” service), or still further, may comprise a subscription service, or another type of service that requires valuable consideration (e.g., a monetary payment). In one embodiment a user of device 2a, 2b, . . . 2n may access platform 3 provided the user has been granted access to such free or “freemium” services, or has been granted access to subscription-based services after providing payment (using an app, for example). Platform 3 may comprise a communications hub (not shown in FIG. 1) operable to provide web-based services, and exchange communications with a user of device 2a, 2b, . . . 2n in order to grant, or deny, the user access to platform 3 (or specific freemium and subscription functions and features (i.e., services) provided by the platform 3) using one or more authentication and registration processes known in the art. Alternatively, such communications may be exchanged between a user (user device) and a third party registrar in order to grant, or deny, the user access to specific freemium and subscription functions and features (i.e., services) provided by the platform 3.

The platform 3 and/or devices 2a, 2b, . . . 2n may comprise the necessary hardware and software for completing the features and functions of systems and methods described herein, as well as at least the following functions: tracking a user's status as a paid user (subscriber) or freemium user, tracking the features and services provided by the platform 3 that have been selected by a user as a freemium or paid user, completing e-commerce transactions (e.g., payment for subscription services), providing customer support features (e.g., help desk, technical support, billing inquiries, etc.), social networking linkage (e.g., to Facebook, Twitter, other accounts), those functions required to support communications (e.g., notifications) via one or more apps, for example, and those functions needed to communicate with a third party service provider.

Each device 2a, 2b, . . . 2n may include an interface. Some non-limiting examples of such an interface are a graphical user interface (GUI), web browser, keyboard, touch screen, display, voice recognition system, an interface used by disabled individuals, or some combination of such devices, to name but a few of the many examples of an interface. Each interface may comprise the necessary electronics (such as one or more processors) specially designed and programmed to complete the features and functions described herein, for example, by accessing integrated instructions stored in memory and/or data stored in memory in order to complete one or more of the assessments described herein. By way of example, one function may be to exchange communications with the platform 3 or another device via a web browser or an app, for example. In more detail the interface may be operable to generate and display a web page, view, etc., that allows the user of a device 2a, 2b, . . . 2n to input information that is eventually transmitted to the platform 3, or to view information that is transmitted from platform 3, in order to complete one or more of the assessments described herein, and receive results of such assessments.

In one embodiment the network 4 may be a wired or wireless network, such as the Internet, an Intranet, secure network, 3G, 4G, LTE, LTE-Advanced, 5G or more advanced network, local area network (LAN), or wide area network (WAN) to name just a few of the many types of networks.

Platform 3 may comprise a plurality of hardware servers 6 that are part of a cloud-based data center or data centers. Still another example is a plurality of virtual machines stored on a hardware server or computer, for example. In either embodiment, the platform 3 may be operable to provide assessments (e.g., online assessments) to users of devices 2a, 2b, . . . 2n based on stored, specially coded electronic instructions stored in memory that is a part of the platform 3 or that is part of a separate memory and based on data (e.g., content) stored in one or more databases 5, for example.

It should be understood that while the platform 3 is shown in FIG. 1 as including four elements (e.g., servers) 6 this is merely exemplary. Alternatively, the platform 3 may be combined into fewer elements or further separated into additional elements. Yet further, the functions completed by each element 6 making up the platform 3 may be distributed, that is, the functions may be separated into individual or grouped functions that are completed by separate elements that may, or may not be, co-located. In an embodiment, one or more of the elements 6 may be operable to execute instructions to complete features and functions related to one or more of the assessments described herein, generate assessment results and send such results on to a user of device 2a, 2b, . . . 2n, for example.

Alternatively, the elements 6 may comprise one or more processors especially designed and programmed to complete the features and functions described herein by, for example, accessing instructions stored in memory and/or data stored in memory, or accessing data in a database Sand executing such instructions to complete features and functions of one or more of the assessments described herein, generate assessment results and send such results on to a user of device 2a, 2b, . . . 2n, for example. Similarly, the elements 6 may comprise a number of subsystems Each of these subsystems 6 in turn may comprise one or more processors specially designed and programmed to complete the features and functions described herein by, for example, accessing instructions stored in memory and/or data stored in memory to complete one or more of the assessments described herein, generate assessment results and send such results on to a user of device 2a, 2b, . . . 2n. It should be understood, however, that depending on the feature or function, each of the subsystems 6 need not necessarily include a processor, and memory.

In embodiments of the invention, rather than be “always on” each of the devices 2a, 2b, . . . 2n and platform 3 (and any subsystems) may be configured themselves, and in relation to one another, so that each is activated (i.e., “turned on”) only as needed to provide the functionality required to provide a particular capability (e.g., utility) or service. Examples of such utilities include, but are not limited to “notification” and “binder” utilities. In one embodiment, a notification utility generates notifications or messages that may be transmitted to, or from, a user (i.e., user device). Such notifications may be part of an associated service, for example.

It should be understood that the platform 3 may include one or more databases 5 operable to store information in the form of text, audio, video, image or some combination of such information in a plurality of desired formats for ease of storage, retrieval and eventual usage by the platforms and devices described herein. Though only a single database 5 is shown in FIG. 1 this is merely illustrative. In alternative embodiments, multiple databases 5 may be included in the system 1. In an embodiment of the invention, the platform 3 may be operable to provide data (e.g., content) within databases 5 to a device 2a, 2b, . . . 2n as part of a content-as-a-service. Such a service may be provided to a user of a device 2a, 2b, . . . 2n as a standalone service or may be combined with other information and provided to a user of a device 2a, 2b, . . . 2n where it may be communicated to a user via an interface. Such a content-as-a-service may be combined with one or more other services described herein.

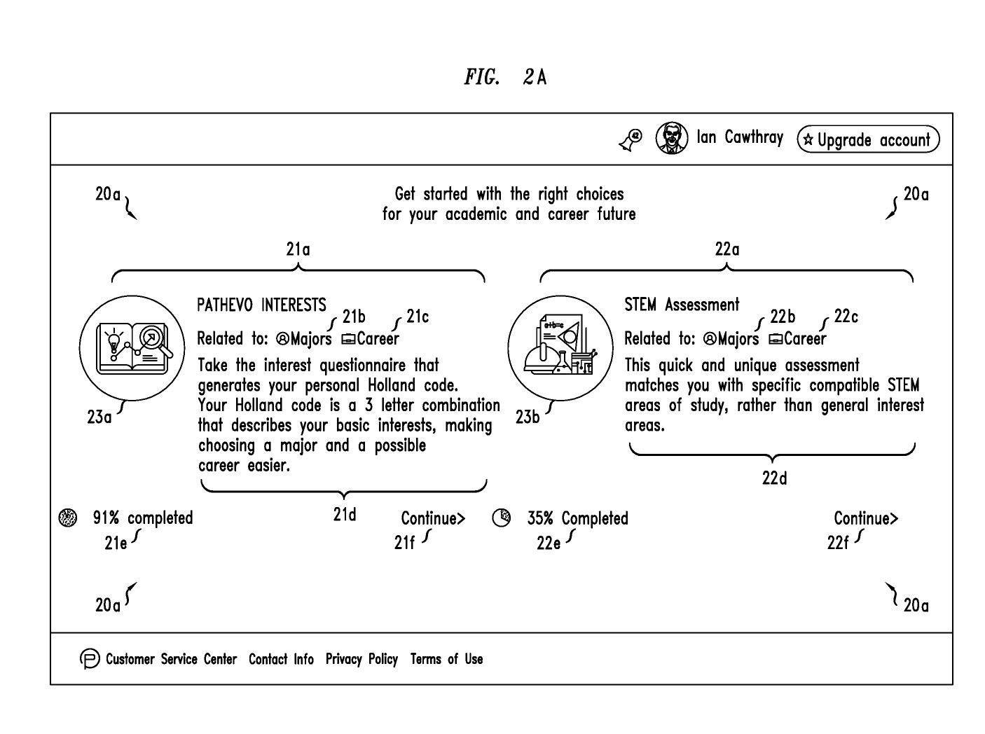

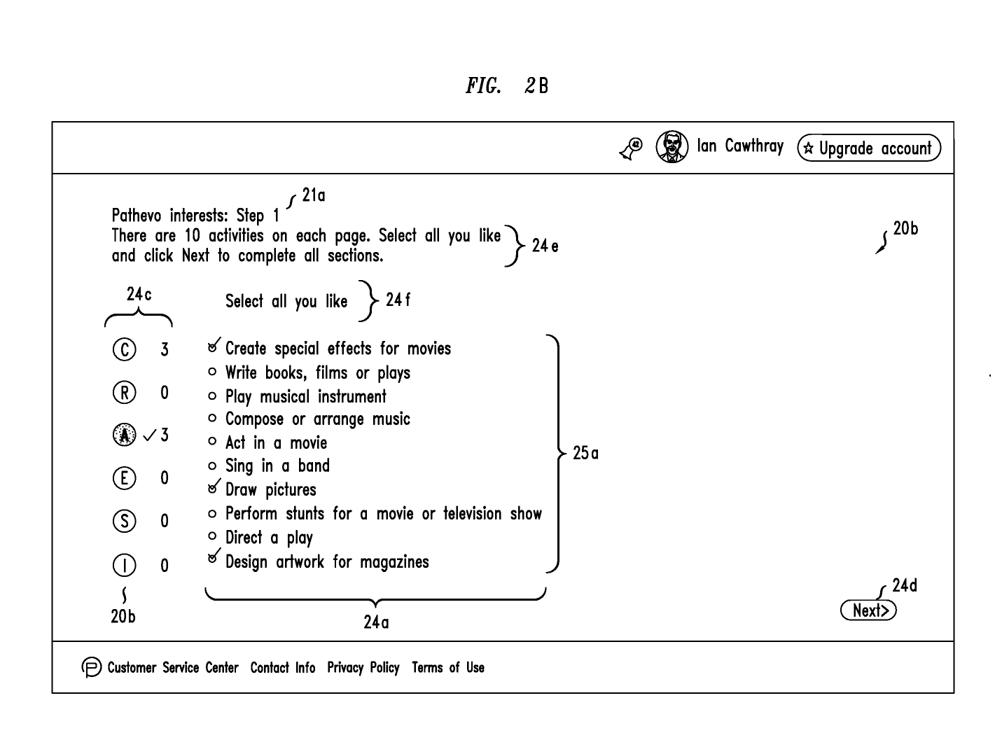

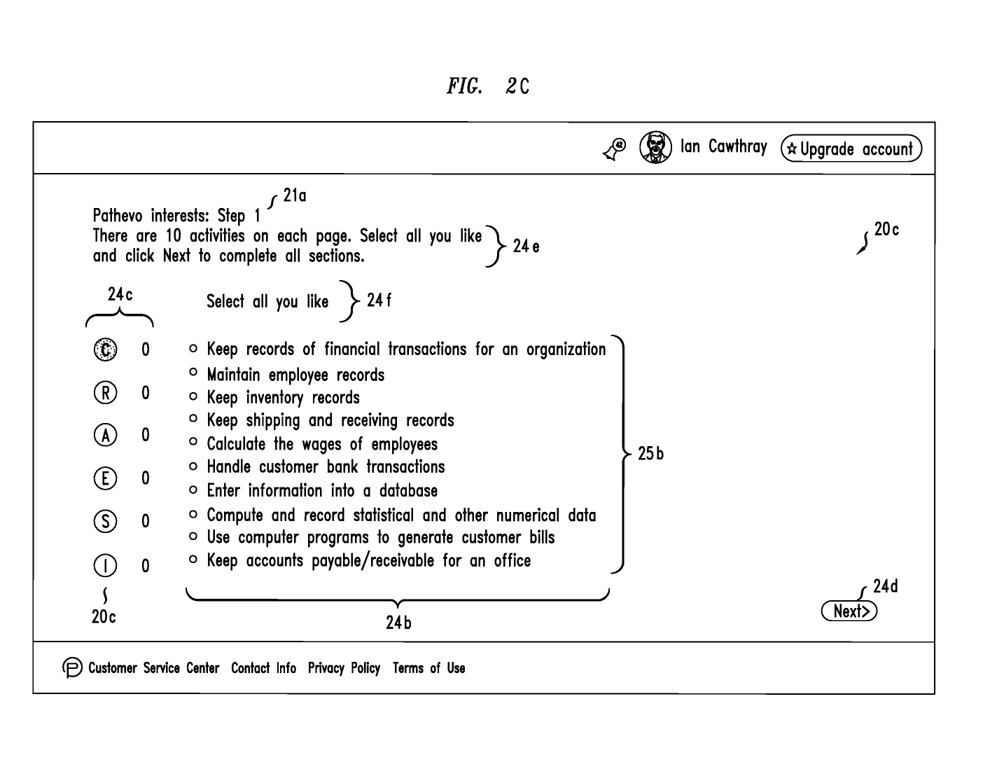

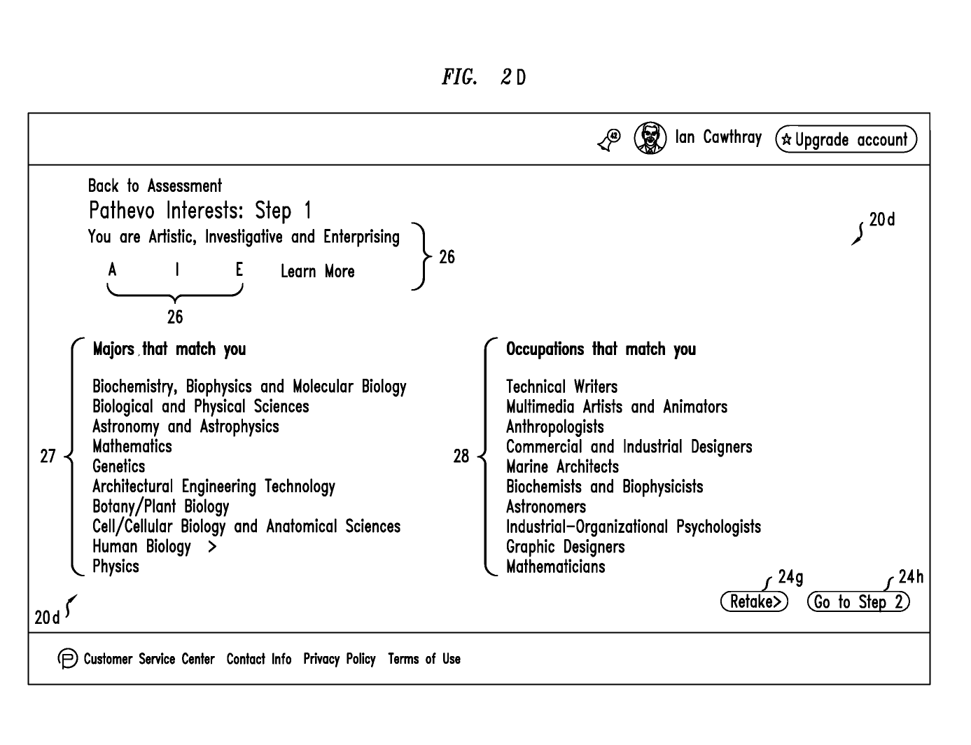

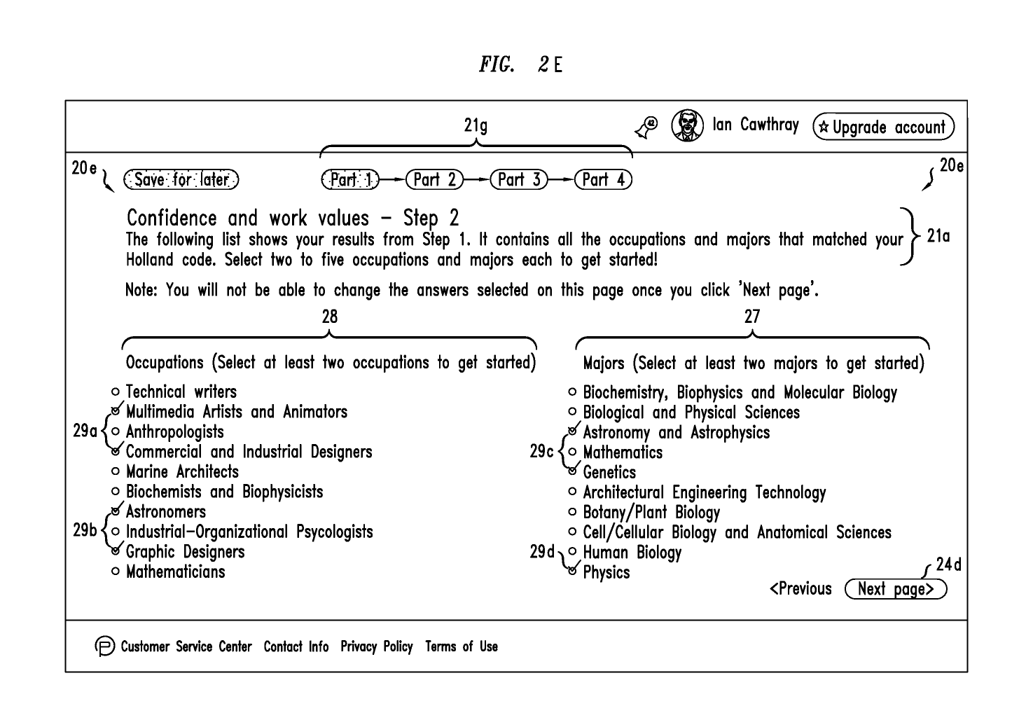

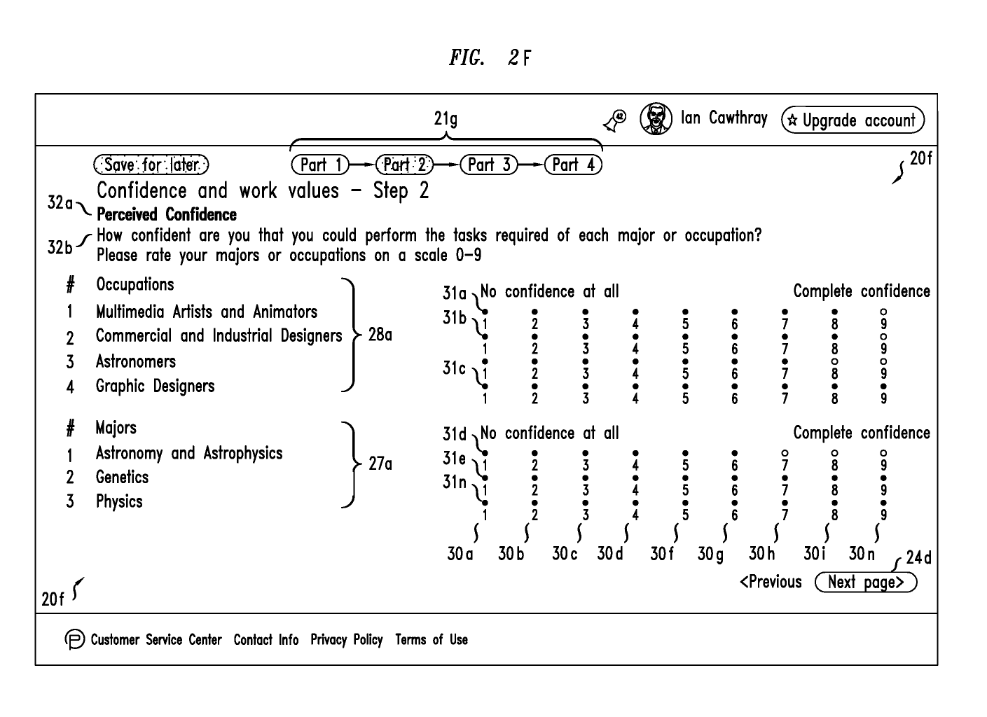

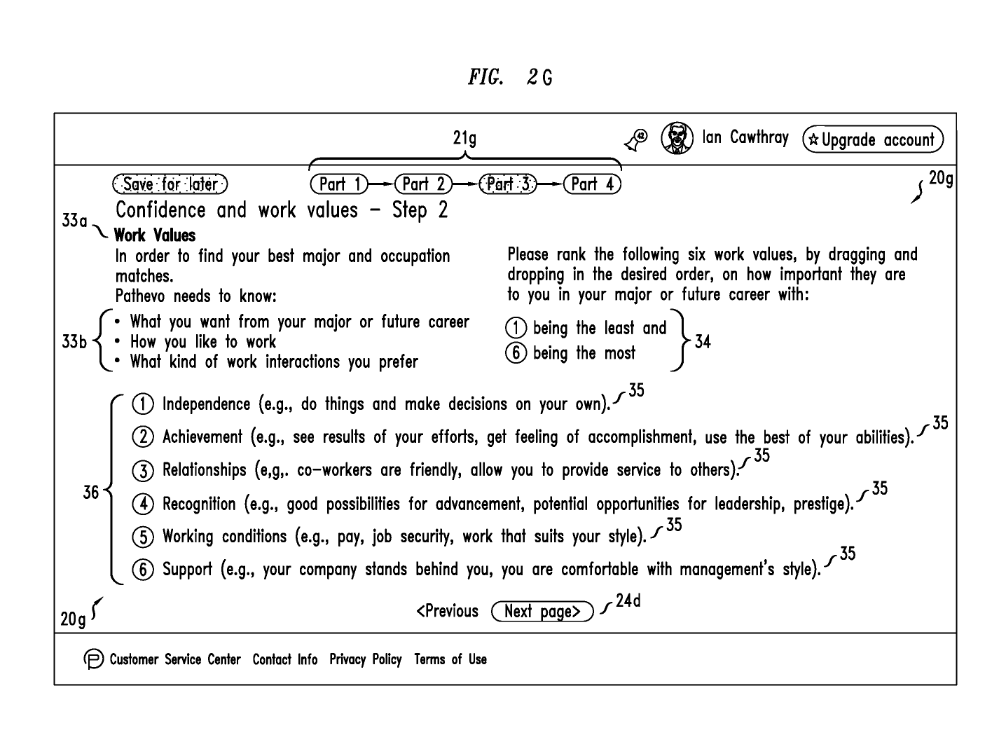

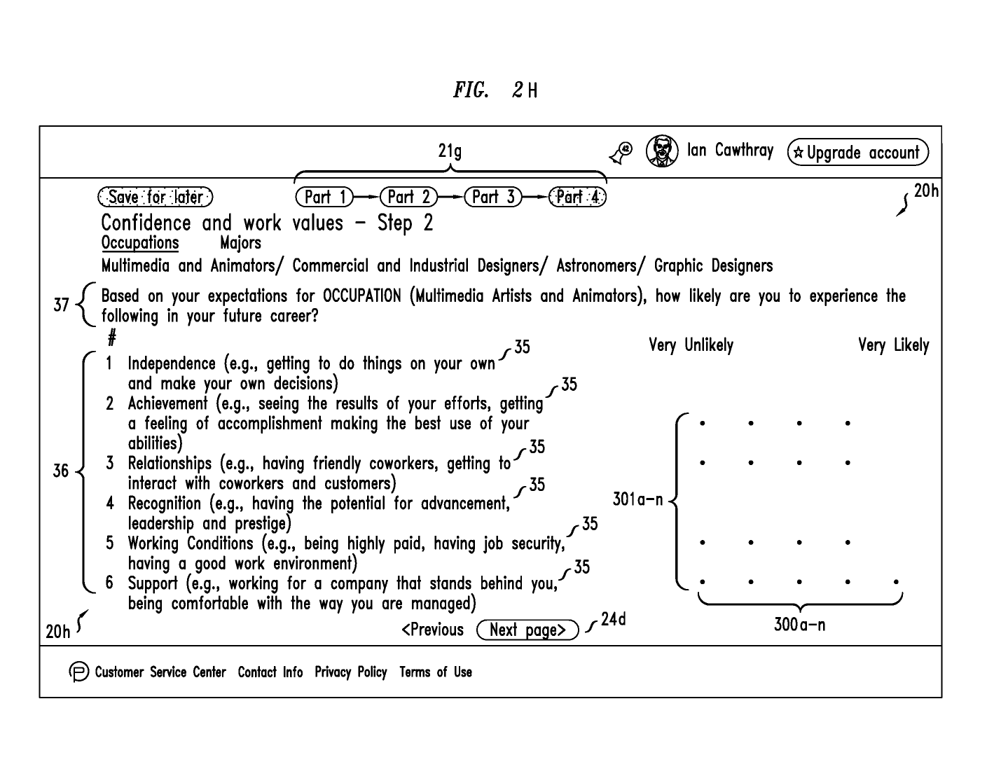

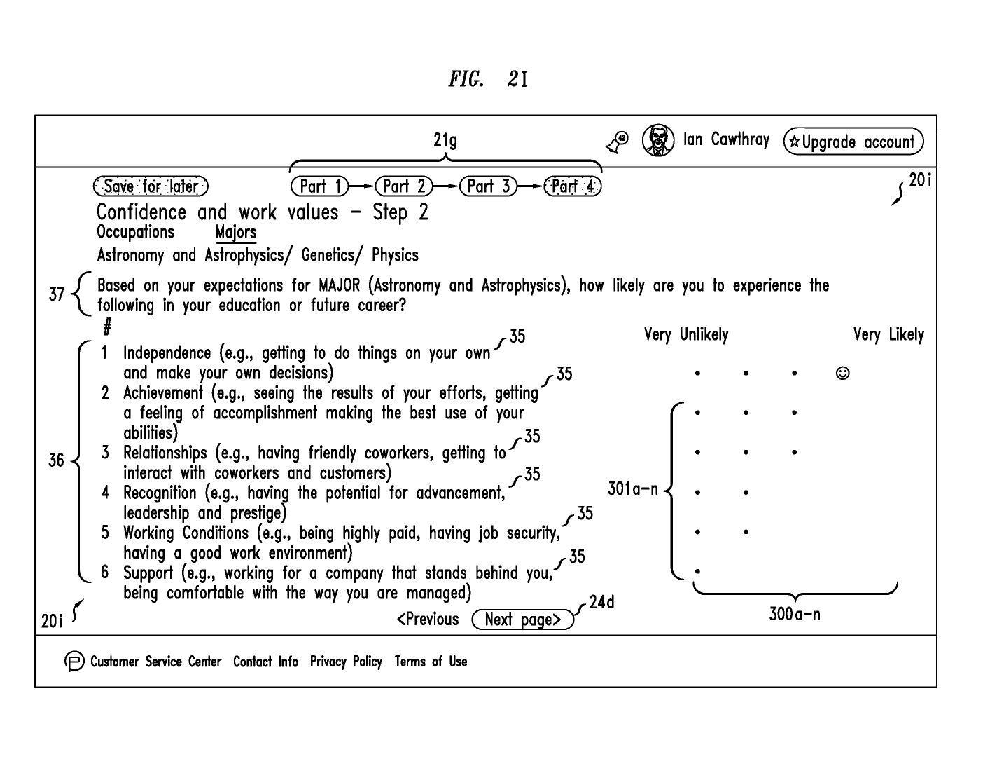

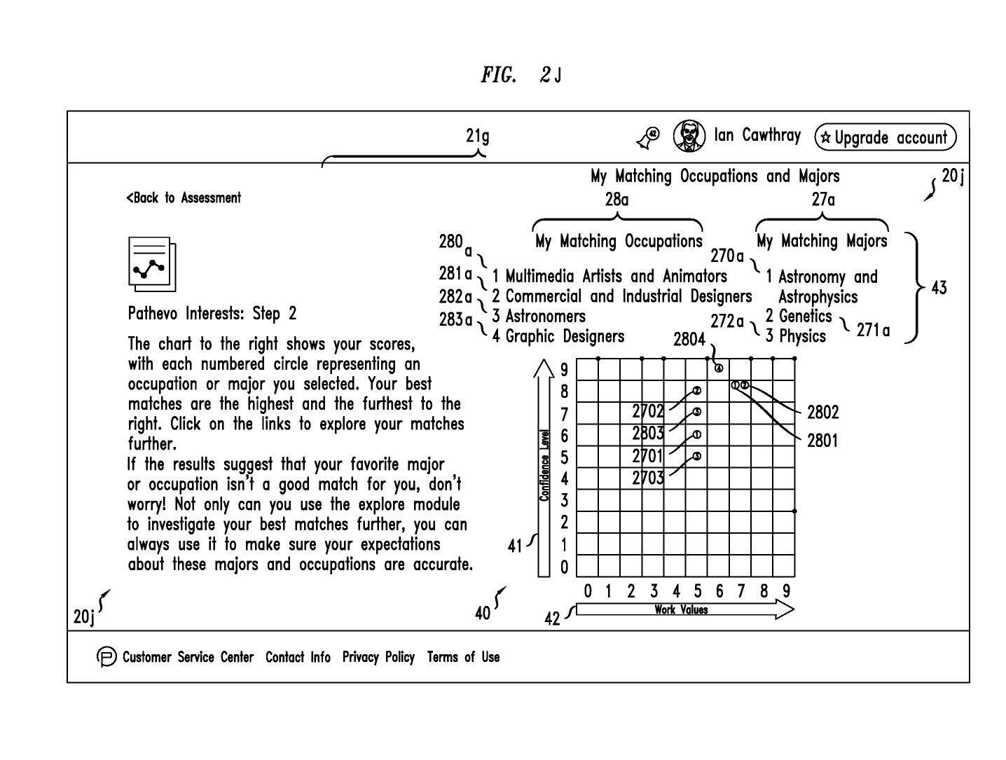

In one embodiment, elements 6 may be operable to send and receive data (e.g., content) from databases 5, and provide a user of a device 2a, 2b, . . . 2n with such data that may be communicated (e.g., displayed) by an interface of such a device as a web page, view, etc., (see FIGS. 2A to 2J, for example). This allows a user to input information and/or select features in order to complete one or more assessments described herein, for example. In embodiments of the invention, the information input or selected by a user may be communicated to the platform 3. Upon receiving this information, the platform 3 may be operable to complete one or more of the features or functions described elsewhere herein.

It should be understood that the information provided, or feature selected, by a user of a device 2a, 2b, . . . 2n may eventually be stored in database 5, and/or within a memory section within device 2a, 2b, . . . 2n, and/or within a third party database (not shown in figures). So too may the results of an assessment be stored within database 5. In an embodiment, the platform 3 may be operable to form a personal assessment profile for each user that comprises, for example, attributes of a user such as age, nationality, employment status, health, years of education, years of employment, geographic location, gender, academic grades, academic accomplishments, skills, hobbies, vocational accomplishments, personality properties, information input by a user, the selections made by a user and the results of one or more assessments, for example (described in more detail elsewhere herein). The platform 3 may be operable to access the profile as part of a process to provide another assessment, to provide another service to a user or to screen data received from a source other than the platform 3 (e.g., a third party). A user's profile may be updated through communications exchanged by a given user of a device 2a, 2b, . . . 2n with the platform 3 and/or through communications with other systems (not shown in FIG. 1), or may be inferred by the platform 3 using one or more inferential models stored within platform 3 or accessible by platform 3.

It should be understood that each of the physical embodiments of the system 1 (e.g., platform 3, elements (e.g., servers) 6, devices 2a, 2b, . . . 2n, and database 5) and other devices described herein are configured with the necessary electronics to enable each to process information much faster than humanly possible and to exchange information much faster than humanly possible. That is to say, each of the embodiments of the present invention cannot practically be implemented by a human being alone as a substitute for the systems, methods and devices described herein in any amount of time that would be acceptable to one skilled in the art. For example, many of the embodiments described herein involve an exchange of information via a network between a physical user device and network device that are remotely located from one another, where the information exchanged must be available for immediate communication to a user operating a device involved in the exchange of information. Accordingly, the speeds at which the information is exchanged, and the amount of information exchanged is many times faster than can be communicated and processed by the human mind. Nor can such information be displayed by the human mind or mechanical means (pen and paper) within the time periods demanded by the expected users of the present invention and those skilled in the art of the present invention.

As noted herein, the platform 3 and devices 2a, 2b, . . . 2n may communicate over a communications network 4. It should be understood, however, that the network 4 may comprise one network or multiple networks. Further the network or networks may be the same type of network (e.g., wired, wireless) or different networks and may use the same access technologies and protocols or different ones (e.g., CDMA, TDMA, GSM, OFDM, etc.). For example, the network 4 may comprise at least two network types, a first network type that devices 2a, 2b, . . . 2n access, and over which user data is transported (i.e., transmitted) to the platform 3 (herein may be referred to as “received user data”), and a second network type that platform 3 accesses to transport data to the devices 2a, 2b, . . . 2n.

The systems and methods provided by the present invention are operable to link or otherwise match the results of an assessment to an academic major and/or occupation, and, in alternative embodiments, eventually to an academic institution, vocational institution or potential employer. Further, unlike existing techniques the systems and methods provided by the present invention further refine the results of a current or historical assessment based on “confidence levels” and “work values” described in more detail elsewhere herein. Still further, as mentioned previously systems and methods provided by the present invention make use of user profiles to screen, filter or otherwise identify data received from a third party source that best matches attributes of such a profile.

FIGS. 2A through 2J depict exemplary visuals 20a, 20b,. . . 20n (where “j” is the last visual) that may be generated by a device 2a, 2b, . . . 2n in communication with a platform 3 via a communications network 4, for example. The visuals 20a, 20b, . . . 20j may be communicated (e.g., displayed) using a GUI of a device 2a, 2b, . . . 2n and a browser of such a device, for example, along with instructions stored in a memory of the device 2a, 2b, . . . 2n which may, or may not be, part of an app. The visual 20a in FIG. 2A, may represent a web page associated with one or more assessments, or a view when so-called single page web sites or an app is used to communicate between the platform 3 and device 2a, 2b, . . . 2n, for example. Accordingly, in describing visuals herein the words “web page”, “view” and “visual” can be used interchangeably unless the context or common sense dictate otherwise. It should be understood that the layout, format and content (e.g., text, images, graphics, links, icons, audio sections, logos) of the visuals depicted in FIGS. 2A through 2J are merely exemplary. Said another way, the layout, format and content of each visual may be changed (deletions, additions, editions) and still fall within the scope of the present invention.

Visual 20a is depicted as including an interest assessment section 21a. In one embodiment, a user may initiate an interest assessment by selecting the icon 23a (e.g., clicking on the icon 23a). Thereafter, as depicted in exemplary FIGS. 2B through 2J, a user may input data into his or her device 2a, 2b, . . . 2n in response to presented selections, queries or prompts, for example, presented to the user via the visuals 20a through 20j. In an embodiment, data input by a user of device 2a, 2b, . . . 2n in response to a presented selection, query, prompt, etc., may be transmitted from the device 2a, 2b, . . . 2n to the platform 3 via network 4. In one embodiment, upon receipt of such user assessment data the platform 3 may be operable to compare the received user assessment data to a plurality of reference data, and identify which reference data best matches the received assessment data based on the comparison in order to identify one or more reference academic majors and/or reference occupations that best matches the received the user assessment data. In the example above, the user assessment data comprises “current” assessment data that is based on the contemporaneous completion of an assessment by a user, and transmission of the data to the platform 3. Alternatively, the user assessment data may comprise historical assessment data that is based on the completion of an assessment by a user at a time that is substantially before the transmission (or re-transmission) of such data to the platform 3.

More particularly, an example of user assessment data is current or historical user interest data. Even more particular, an example of user interest data is current or historical Holland code-associated user data (an example of the later is a Holland code the user has received as a result of completing a previous assessment). Holland codes are described in more detail elsewhere herein.

In alternative embodiments, the user assessment data may comprise STEM assessment data, STEAM assessment data (adds “arts” to the categories of science, technology, engineering and math), PGI assessment data, skills assessment data, aptitude assessment data, personality assessment data, work-related assessment data, and/or data from other assessments that have psychometric properties. In the latter, such an assessment has been subjected to validity and test-retest reliability studies.

In one embodiment of the invention, when current Holland code associated user data is involved, the platform 3 may be operable to generate current, Holland type codes from such data and then match the generated code(s) to a reference academic major (e.g., genetics) or to a reference occupation, such as a STEM occupation, for example, that best matches the current Holland type codes and current Holland code assessment user data in order to identify the one or more reference academic majors or occupations.

More generally, upon receipt of Holland code associated user data (current or historical), or user assessment data, where the data comprises current or historical user interest data, the platform 3 may be operable to compare the received Holland code associated user data or user interest data to a plurality of user interest reference data, and identify which reference data best matches the received user interest data based on the comparison in order to identify the one or more reference academic majors or reference occupations that best matches the received user interest data.

In more detail as is known in the art, Holland codes are based on the Holland Vocational Personality Theory (“Theory”). This Theory is based on the idea that an individual, who has a certain personality type, is drawn to a particular career(s) and working environment(s).

Activities such an individual engages in typically encompasses unique sets of strategies, approaches, and required skills. Thus, exposure to, and continued participation in, certain activities, along with more inherent factors such as parental and community influences, can systemically shape the cognitive ability and personality of the individual from an early age. For example, interest in one activity may develop into interest in an entire category or categories of activities while at the same time encouraging distinct preferences for certain categories to the exclusion of others. Such exclusion may result in an individual developing a unique personality type that is the product of an individual's particular life experiences.

In embodiments of the invention that make use of Holland codes the personality types may be categorized as Realistic (R), Investigative (I), Artistic (A), Social (S), Enterprising (E), and Conventional (C). It should be understood that these six categories are not exclusive categories. Said another way, many individuals will find that they have interests and abilities in several categories. Further, one personality type may be highly complementary to at least one other personality type, while being diametrically opposed to another personality type. Together, three or more of the categories (e.g., three to six letters, such as “R I A”) are collectively considered a valid Holland code (referred to as a “Holland code” herein). More particularly, the order of the categories (i.e., letters) typically reveals those traits or characteristics of an individual that are more dominant (or less dominant as the case may be) than other categories. For example, a three letter Holland code represented by the letters “A E S” may be interpreted as indicating that an individual associated with this Holland code has a most dominant artistic trait (“A”) because the “A” is the first letter in the code, while the same individual has a less dominant enterprising trait (“E”) and least dominant social trait (“S”) which is the last letter in the code (from left to right). Similarly, if a six letter Holland code represented by the letters “A E S R I C” may be interpreted as indicating that an individual associated with this Holland code also has a most dominant artistic trait (“A”) because the “A” is the first letter in the code, while the same individual has a least dominant conventional trait (“C”) which is the last letter in the code (from left to right).

As depicted in FIGS. 2A through 2J and visuals 20a through 20j, an exemplary method implemented by the platform 3 and devices 2a, 2b, . . . 2n (collectively, hereafter referred to as “device 2a” for short though it should be understood that one, or more than one, device may be involved depending on the context) involves presenting a series of visuals that together form a Holland code based interest assessment to a user on device 2a. In this embodiment, it is assumed that the user of device 2a has not completed a previous Holland code type assessment, or, has forgotten the Holland code that was generated from such a previous assessment. In either case, a new assessment may be generated by the platform 3 in the form of data and then transmitted to the device 2a via network 4, for example. As described more below and elsewhere herein, upon receipt of the assessment and depiction of the assessment as visuals 20a through 20j, for example, on a GUI of device 2a a user may be operable to input responses to the Holland code based interest assessment.

Such responses (sometimes referred to herein as “current Holland code associated user data”) may be transmitted to the platform 3 via network 4. Thereafter, the platform 3 may be operable to generate an exemplary assessment result, such as a three-letter current Holland code based on the received user data, for example. Thereafter, the so-generated (three to six-letter) Holland code may be transmitted as data from the platform 3 to the device 2a via network 4 for communication to a user via text, audio, video or images, (e.g., visuals 20a to 20n).

More generally, in other embodiments “user assessment data”, “user interest data”, or just “user data”) may be generated by the device 2a based on responses to some type of assessment which may be a Holland code type of assessment, or another type of assessment.

In more detail, the platform 3 may be operable to receive current Holland code associated user data and identify a current, assessed Holland code that best matches the user data, and, one or more reference academic majors or occupations, for example, that best matches the current, assessed Holland code (i.e., that are most closely associated with the assessed Holland codes). In an alternative embodiment, when the platform 3 receives Holland code associated user data that is based on an historical Holland code, the identification of the current, assessed Holland code may be skipped, and, instead proceed to the identification of the one or more reference academic majors or occupations, for example, that best matches the historical Holland code (i.e., its associated Holland code associated user data).

In an embodiment, the identification of a current, assessed Holland code based on received, current Holland code associated user data may involve the platform 3 comparing the received user data to a plurality of Holland code reference data that is stored within the platform 3 or in another memory or database. The set of the reference data may be associated with one or more reference academic majors or occupations, for example. Upon completion of the comparison, or during a comparison sequence, the platform 3 may be operable to identify which set of reference data best matches the received user data in order to identify the assessed Holland code and, ultimately, to identify one or more reference academic majors, or occupations (e.g., STEM occupations) associated with the assessed Holland code. Further, upon identifying the majors or occupations, the platform 3 may be operable to identify one or more academic institutions, vocational institutions or potential employers based on the identified, reference academic majors or occupations; and transmit data representing the one or more academic institutions, vocational institutions or potential employers, to the device 2a, for example.

The Holland code which results from a comparison, identification and matching may be referred to herein as the “current, assessed” Holland code or just “current Holland code” to distinguish it from historical Holland codes and associated reference data.

Again, in alternative embodiments when the platform 3 receives Holland code associated user data that is based on an historical Holland code, the identification of a current, assessed Holland code may be skipped, and, instead proceed to the identification of the one or more reference academic majors or occupations, for example, that best matches the historical Holland code (i.e., its associated Holland code associated user data). In an embodiment, the platform 3 may be operable to compare the received Holland code associated user data associated with an historical Holland code to a plurality of Holland code reference data that is stored within the platform 3 or in another memory or database. The set of the reference data may be associated with one or more reference academic majors or occupations, for example. Upon completion of the comparison, or during a comparison sequence, the platform 3 may be operable to identify which set of reference data best matches the received user data in order to identify the historical Holland code and, ultimately, to identify one or more reference academic majors, or occupations (e.g., STEM occupations) associated with the historical Holland code. Further, upon identifying the majors or occupations, the platform 3 may be operable to identify one or more academic institutions, vocational institutions or potential employers based on the identified, reference academic majors or occupations; and transmit data representing the one or more academic institutions, vocational institutions or potential employers, to the device 2a, for example.

It should be understood that STEM occupations are just a few of the many types of occupations that may be identified. In alternative embodiments, non-STEM occupations, such as a trade (carpenter, electrician, plumber, mason, etc.,) law, the arts, marketing, finance, economics, healthcare or music and the performing arts, to name just a few non-STEM occupations, may be identified.

After identifying the current, assessed Holland code an exemplary platform 3 may be operable to transmit data, representing the current, assessed Holland code, and data representing the one or more associated reference academic majors or occupations, academic institutions, vocational institutions or potential employers over the communications network 4, to an electronic device 2a being accessed or otherwise operated by the user.

More generally, the platform 3 may be operable to transmit data representing the one or more reference academic majors or occupations that best match the received data (e.g., assessment data, user interest data, or current/historical Holland code associated user data) and/or results, and/or academic institutions, vocational institutions or potential employers to the device 2a over the network 4 in a textual, audio, video or image formatted data or some combination of such formatted data, for example.

In embodiments of the invention, based on a six letter Holland code, 720 possible historical Holland codes may be used or may be generated as current, assessed Holland codes by the platform 3 in response to user data it receives from a device 2a. Current, assessed Holland codes may be identified based on inputs, answers, responses or selections made by a user of such a device 2a who is completing an assessment that may be depicted as a visual on a display of device 2a, for example.

In embodiments of the invention, an assessment may consist of a sequence of visuals 20b and 20c, for example, depicted in FIGS. 2B and 2C, respectively. In the embodiments depicted in FIGS. 2A through 2J the assessment shown is a Holland code type assessment, though it should be understood that other assessments and associated visuals may be generated. In the latter case, the visual may be formatted differently than shown, and may include different content, icons, images, text, etc., than shown, in order to closely relate the visual to the type of assessment.

In the embodiments depicted in FIGS. 2b and 2C, each visual may include a list 24a, 24b, respectively, of activities 25a,25b, respectively (e.g., 10 activities) that an individual might perform for each Holland code category (e.g., six categories). In an embodiment of the invention, the activities 25a,25b included in a list 24a, 24b may be selected randomly. That is, in an embodiment, the platform 3 may be operable to generate a list of random categories and transmit such a list to a device 2a via network 4, for example.

Referring now to FIG. 2B, upon being presented with the visual 20b a user may select those activities 25a within the list 24a that the user likes the most by clicking on, or otherwise selecting, the individual activities 25a or an associated icon. The user's selection(s) may then be transmitted to the platform 3.

Similarly, referring now to FIG. 2C, upon being presented with the visual 20c a user may select those activities 25b within the list 24b that the user likes the most by clicking on or otherwise selecting the individual activities 25b or an associated icon. Once again, the user's selection(s) may then be transmitted to the platform 3.

This process of presenting a list of activities, selection of activities, and transmission of the selected activities to the platform 3 may be repeated, for example, for each Holland code category.

More particularly, after the user has selected activities from a list within a displayed visual, data representative of the activities selected—i.e., current Holland code associated user data—is transmitted from the device 2a to the platform 3 via network 4, for example. Thereafter, the platform 3 may be operable to complete the features and functions (e.g., reception, mapping, comparison and identification processes) described above and elsewhere herein.

In one embodiment, the platform 3 may be operable to determine the top three activities from the received user data, and rank the activities from the most interested to least interested activity for a given user. The platform 3 may be operable to map or associate the so ranked activities to a current, assessed Holland code (e.g., a three to six letter Holland code), reference academic major(s) and occupation(s), academic institutions, vocational institutions or potential employers. Thereafter, the platform 3 may be operable to transmit data, representing the current, assessed Holland code, and data representing one or more mapped reference academic majors or occupations, academic institutions, vocational institutions or potential employers that correspond to the current, assessed Holland code to a device 2a over the communications network 4, for example.

Once again, it should be noted that where historical Holland code associated user data is involved, the platform 3 may still be operable to determine the top three activities from the received user data, and rank the activities from the most interested to least interested activity for a given user. However, the platform 3 need not map or associate the so ranked activities to a current, assessed Holland code (e.g., a three to six letter Holland code). Instead, the platform 3 may be operable to map the user data to reference academic major(s) and occupation(s), academic institutions, vocational institutions or potential employers. Thereafter, the platform 3 may be operable to transmit data representing one or more mapped reference academic majors or occupations, academic institutions, vocational institutions or potential employers that correspond to a device 2a over the communications network 4, for example.

The mapping (and subsequent revelation of such mapping to a user) of the received user data to a reference academic major, reference occupation, or to both, and further to academic institutions, vocational institutions or potential employers is believed to be an improvement over existing techniques that are not capable of doing such a complete mapping and revelations (e.g., transmitting the results of the mapping to a user device).

Referring now to FIG. 2D there is depicted a visual 20d that includes a section 26 that indicates an exemplary three letter current, assessed Holland code, a section 27 that indicates those exemplary, reference academic majors that are associated with, or correspond to, the current, accessed Holland code in section 26 and a section 28 that indicates those exemplary occupations (e.g., STEM occupations) that are associated with, or correspond to, the current, accessed Holland code in section 26.

In embodiments, platform 3 may provide the academic majors in section 27 and occupations in section 28 to a device 2a. The so provided majors and occupations may be directly correlated with (i.e., correspond to) the Holland code in section 26, or, alternatively, may be indirectly correlated with a Holland code that is similar to the Holland code in section 26, for example.

That is, the comparison of received user data to reference data may reveal that there is no exact match between a current, assessed Holland code and reference academic majors and occupations. Should this occur, the platform 3 is operable to identify the reference majors and occupations that best match the current, assessed Holland code. This process may be referred to as an indirect correlation.

The inclusion of academic majors or occupations that are indirectly correlated to a current, assessed Holland code enables the systems and methods provided by the present invention to capture variabilities inherent in the Holland coding system and use these variabilities to provide a user with a broad set of academic majors and/or occupations.

Though not shown in FIGS. 2A to 2J, in alternative embodiments the device 2a may be operable to generate visuals 2A to 2J that include one or more sections that include the identified academic institutions, vocational institutions or potential employers.

In accordance with additional embodiments of the invention, unlike existing assessments, assessments provided by the present invention further customize or refine the majors and occupations that are associated with current, assessed Holland codes or associated with historical Holland codes by applying confidence level and work value factors or filters to such majors and occupations.

The rationale for doing so is to help the user to further focus on just those majors and occupations that best fit their work preferences, work values, and confidence levels. Said another way, the goal is to match a user (e.g., student) with the majors and occupations for which they are best suited and to which they feel the most prepared. Work preferences, work values, and confidence levels are discussed in the work of Lent, Brown, and Hackett's Social Cognitive Career theory. This theory suggests that there are two factors that can lead to an individual's (e.g., student) decision not to pursue a major or occupation or another career option, namely: self-efficacy (beliefs about one's ability to succeed) and outcome expectations (beliefs about the outcomes of performing particular behavior). According to the theory, longevity and success in careers are regulated by positive beliefs involving these factors. For example, students that record high scores (e.g., test scores) in subjects related to particular majors or occupations will most likely be motivated to explore such majors or occupations further because of a belief that scoring high on a test will ultimately result in being successful in a field related to the major or occupation.

Referring now to FIG. 2E there is depicted a visual 20e in accordance with another embodiment of the invention. As shown, the visual 20e may include sections 27, 28 and 29a, b , . . . n (where “n” is the last section). Sections 27 and 28 are similar to sections 27, and 28 in FIG. 2D though the list of reference majors in section 27 and list of reference occupations in section 28 may be formatted differently. In accordance with an embodiment, a user of a device 2a, 2b, . . . 2n that has been presented with visual 20e may select two or more of the majors within section 27 and two or more occupations within section 28 for further assessment as described below and elsewhere herein. It should be understood that while it is preferable to select two or more majors and two or more occupations, strictly speaking this is not a requirement, and an embodiment that selects one major and/or occupation is within the scope of the present invention. The use of two or more majors and occupations assists in the plotting of, or charting of, outcomes which typically requires at least two different data points (majors, occupations).

The selection of a major or occupation by a user may be made using one or more methods, such as by use of an indicator (e.g. a check mark) such as those shown in sections 29a,29b, . . . 29n or highlighting each selected major or occupation, or clicking on each selected major or occupation to name just a few of the many ways in which a major or occupation may be selected from a list 27,28.

The majors and occupations that are so selected may be transmitted (i.e., data representing the selections may be transmitted) from a device 2a over the communications network 4 to the platform 3.

Referring now to FIG. 2F there is depicted a visual 20f according to an embodiment of the invention. As depicted, the visual 20f includes a section 32a that indicates the assessment will now focus on the assignment of confidence levels to previously selected reference majors and occupations by permitting an individual to assign a confidence level to each previously selected major in list 27a and occupation in list 28a (see FIG. 2E and the related discussion). In embodiments of the invention, each of the selected majors and occupations within lists 27a,28a may be associated with a confidence level meter 31a to 31n (where “n” indicates the last meter). The confidence meters 31a to 31n may be used to indicate the level of confidence an individual/user has in his or her ability to perform the tasks required by each selected major or occupation, for example. Further, each meter 31a to 31n may comprise a plurality of confidence level indicators 30a to 30n (where “n” is the last indicator). In one embodiment, a first indicator 30a may indicate a lowest level of confidence, while a last indicator 30n may indicate a highest level of confidence and each intermediate indicator in between indicator 30a and 30n may indicate a gradual increase in the level of confidence between a lowest level and highest level (proceeding from 30a to 30n). That is to say, each intermediate indicator is assigned a confidence level that differs from a previous indicator and a subsequent indicator. Thus, the confidence level indicators may be viewed as a measure of self-efficacy (i.e., confidence level), that requires a user (e.g., student) to evaluate their confidence in performing the necessary tasks and daily activities of fields (e.g., reference academic majors, occupations) in which they are interested.

In an embodiment, a user may select (or otherwise input into the device 2a) a confidence level indicator 30a to 30n within each meter 31a to 31n that is associated with an occupation or major using a plurality of ways and means, including clicking on a selected indicator or indicators 30a to 30n for example, to name just one of the many ways in which a confidence level indicator 30a to 30n may be selected. Thereafter, the device 2a may be operable to transmit user data representing the selected confidence level indicators associated with the selected majors and occupations, and thus associated with a current or historical Holland code, for example, to the platform 3 via network 4. Thereafter, the platform 3 may be operable to receive, from the device 2a, the user data that represents the confidence level indicators selected by the user that are associated with each selected academic major and occupation which, in turn, may be associated with a current or historical Holland code.

Referring now to FIG. 2G there is depicted a visual 20g according to an embodiment of the invention. As depicted, the visual 20g includes a section 33a that indicates the assessment will now focus on the assignment of work value factors to the previously selected majors and occupations by first permitting an individual to assign a priority indicator to each major and occupation within lists 27a,28a, respectively, that has been previously selected.

In embodiments of the invention, work values may be based on a set of work value criteria that are indicated in section 33b. In one embodiment, a user may be prompted to first rank or otherwise prioritize the importance of a set of work values 35 using priority indicators 34 (e.g., the numbers 1 to 6, where the number “1” indicates the highest priority or most important work value and the number “6” represents the lowest priority or least important work value). In general, the rank of a priority indicator should reflect its importance to an individual, e.g., how important is it that they can work independently in their future career? In the example shown in FIG. 2G, a user has so prioritized the work values 35 from 1 to 6, where the work value “Independence” is prioritized as “1” (most important) and the work value “Support” is prioritized as “6” (least important). It should be understood that although six priority indicators are used in the example shown in FIG. 2G, this is merely exemplary. Fewer than six or more than six indicators may be used in alternative embodiments of the invention.

In an embodiment, a user may assign a priority indicator 34 (or otherwise input the indicators into the device 2a) using a plurality of ways and means, including clicking on a drop down menu 36 associated with each work value 35 and then selecting a priority indicator (e.g., “1” to “6”) from the drop down menu 36 that the user wishes to assign to a given work value 35, for example, to name just one of the many ways in which a priority indicator 34 may be assigned to a work value 35. Thereafter, the device 2a may be operable to transmit user data representing the assigned, priority indicators 34 for each work value 35 to the platform 3 via network 4. Thereafter, the platform 3 may be operable to receive, over the network 4, from the device 2a the user data that represents the assigned, priority indicators 34 for each work value 35.

The assignment of a priority indicator may be viewed as “weighting” the work values 35. For example, a higher priority indicator (value) for a given work value may, therefore, provide a greater weighting, or consideration for such a work value in the methods discussed herein.

Referring now to FIG. 2H there is depicted a visual 20h according to an embodiment of the invention. As depicted, the visual includes a section 36 that indicates the assessment will focus on the assignment of work expectation indicators to each of the previously selected, weighted work values 35 for one occupation 280a selected from one of the previously selected occupations in list 28a. In an embodiment, a user may select the occupation 280a from the previously selected occupations in list 28a using a plurality of ways and means, including clicking on a drop down menu (not shown in FIG. 2H) associated with the selected list 28a of occupations, and then selecting occupation 280a from the drop down menu that the user wishes to address first, for example, to name just one of the many ways in which an occupation may be selected from the list 28a.

As depicted, each weighted work value 35 is associated with a work expectation level meter 301a to 301n (where “n” indicates the last meter), and each meter 301a to 301n includes a plurality of work expectation indicators 300a-n.

In embodiments, the work expectation level meters 301a to 301n and indicators 300a-n may be used to indicate the likelihood that the user expects to experience the work value 35 associated with a given occupation 280a during the user's lifetime, for example.

In one embodiment, a first indicator 300a may indicate a lowest level of expectation (i.e., the user believes there is little likelihood that he or she will experience a given work value), while a last indicator 300n indicates a highest level of expectation (i.e., the user believes there is a great likelihood that he or she will experience a given work value) and each intermediate indicator in between indicator 300a and 300n (from 300a to 300n) may indicate a gradual increase in the level of expectancy/likelihood between a lowest level and highest level of expectation. That is to say, each intermediate indicator is assigned an expectation/likelihood level that differs from a previous indicator and a subsequent indicator.

In an embodiment, a user may select (or otherwise input into the device 2a) an indicator 300a to 300n within each meter 301a to 301n that is associated with a weighted work value 35 for each selected occupation 280a using a plurality of ways and means, including clicking on a selected indicator or indicators 300a to 300n for example, to name just one of the many ways in which an indicator may be selected. Thereafter, the device 2a may be operable to transmit user data representing the selected indicators associated with a given weighted work value 35 for a given occupation 280a to the platform 3 via network 4. Thereafter, the platform 3 may be operable to receive, over the network 4, from the electronic device 2a the user data that represents the indicators 300a to 300n selected by the user that are associated with each work value 35 for each occupation 280a.

While the visual 20h in FIG. 2H illustrates the selection of indicators for a given occupation 280a (e.g., multimedia artists and animation), it should be understood that a similar process can be followed for each of a plurality of different occupations within list 28a that are previously selected by the user as well as for each of a plurality of academic majors in list 27a that have been previously selected by the user.

For example, FIG. 2I depicts a visual 20i according to an embodiment of the invention. As depicted, the visual 20i includes an indication in section 37 that the assessment will now focus on the assignment of work expectation indicators 300a-300n (where “n” is the last indicator) to each of the previously selected work values 35 for one academic major 270a selected from the plurality of previously selected majors in list 27a. In an embodiment, a user may select the academic major 270a from the previously selected list of academic majors 27a using a plurality of ways and means, including clicking on a drop down menu (not shown in FIG. 21) associated with each academic major making up the selected academic majors in list 27a and then selecting major 270a from the drop down menu that the user wishes to address first, for example, to name just one of the many ways in which major 270a may be selected.

As before, and as depicted, each work value 35 is associated with a work expectation level meter 301a to 301n (where “n” indicates the last meter), and each meter 301a to 301n includes a plurality of work expectation indicators 300a-n.

In embodiments, the work expectation level meters 301a to 301n and indicators 300a-n may be used to indicate the likelihood that the user expects to experience the work value 35 associated with a given academic major 270a during the user's lifetime, for example.

In one embodiment, a first indicator 300a may indicate a lowest level of expectation (i.e., the user believes there is little likelihood that he or she will experience a given work value), while a last indicator 300n indicates a highest level of expectation (i.e., the user believes there is a great likelihood that he or she will experience a given work value) and each intermediate indicator in between indicator 300a and 300n (from 300a to 300n) may indicate a gradual increase in the level of expectancy/likelihood between a lowest level and highest level of expectation. That is to say, each intermediate indicator is assigned an expectation/likelihood level that differs from a previous indicator and a subsequent indicator.

It should be noted that the term “work” expectation indicators is used in conjunction with both occupational and academic environments. Thus, as used herein the term “work” connotes either environment, or both environments.

Continuing now with our description of FIG. 2I, in an embodiment, a user may select (or otherwise input into the device 2a) an indicator 300a to 300n within each meter 301a to 301n that is associated with a work value for the selected academic major 270a using a plurality of ways and means, including clicking on a selected indicator or indicators 300a to 300n for example, to name just one of the many ways in which an indicator may be selected. Thereafter, the device 2a may be operable to transmit user data representing the selected indicators associated with a given work value 35 for a given major 270a to the platform 3 via network 4. Thereafter, the platform 3 may be operable to receive, over the network 4, from the electronic device 2a the user data that represents the selected indicators 300a to 300n that are associated with each work value 35 for each academic major 270a.

While the visual 20i in FIG. 21 illustrates the selection of indicators for a given academic major 270a (e.g., astronomy and astrophysics), it should be understood that a similar process can be followed for each of the plurality of different academic majors in list 27a and each of occupations in list 28a that have been previously selected by a user.

Recall that the platform 3 previously received data representing the confidence levels from the device 2a. Upon now receiving data representing the work expectation indicators the platform 3 may be operable to generate data representing a mapping of the received confidence levels and received work expectation indicators for each of the two or more academic majors and each of the two or more occupations, and then transmit the data representing the mapped confidence levels and work expectation indicators for each academic major and occupation, over the communications network 4, to the device 2a. In more detail, in one embodiment the mapped confidence levels and work value indicators may be configured as a graph or chart as will be described in more detail below with respect to FIG. 2J. Accordingly, the platform 3 may be operable transmit data representing a graphical representation of the mapped confidence level and work expectation indicators for each academic major or occupation, over the communications network 4, to the device 2a. Alternatively, platform 3 may be further operable to transmit data representative of the mapped confidence level and work expectation indicators for each academic major or occupation, over the communications network 4, to the device 2a wherein the data representative of the mapped confidence level and work expectation indicators comprises textual, audio, video or image formatted data or a combination of such formatted data.

Referring to FIG. 2J there is depicted a visual 20j that includes an exemplary matrixed graph or chart 40 that depicts a matrix of reference confidence levels 41 on a y-axis and reference work values 42 on the x-axis of a display of a device 2a. Such a visual may be generated by a GUI, browser, some combination of the two and their required electronics or other means for displaying text and graphical data that is part of device 2a. More particularly, in accordance with an embodiment a device 2a may be operable to generate the visual 20i based on the mapped data received from the platform 3. In an embodiment, the graph 40 may include a visual representation of a matrix of the mapped confidence level and work value expectation for each previously selected occupation in list 28a and academic major in list 27a. In FIG. 2J, the occupations are labeled 280a, 281a, 282a and 283a while the academic majors are labelled 270a, 271a, 272a, and 273a.

The graph 40 visually illustrates how each previously selected major in list 27a and occupation in list 28a have been qualified by a user through the use of confidence level indicators, and work expectation indicators. In one embodiment the user device 2a may be operable to position those occupations or majors that are associated with high confidence levels and high work expectation indicators in the upper right hand portion of the graph 40, and position those occupations and majors that are associated with low confidence levels and low work value expectation indicators in the lower left hand portion of the graph 40. Further, the user device 2a may be operable to position those occupations or majors that are associated with high confidence levels but low work expectation indicators in the upper left hand portion of the graph 40, and position those occupations and majors that are associated with low confidence levels but high work value expectation indicators in the lower right hand portion of the graph 40. Said another way the quality or strength of a selected occupation in list 28a or major in list 27a may increase from a position on the origin of the graph 40 towards the upper right hand portion of the graph 40, where strength or quality is a measure of the user selected confidence levels and work values expectation indicators for each occupation and academic major.

In an embodiment, the matrixed graph 40 may include graphical indicators 2801, 2802, 2803 and 2804 for each of the occupations that are positioned and graphical indicators 2701, 2702, 2703 for each of the academic majors that are positioned. Yet further, each of the graphical indicators 2801,2802,2803, 2804 and 2701, 2702 and 2703 may include an identifier, such as a numerical identifier (e.g., 1, 2, 3 and 4) or other distinguishing identifier, for ease of identification within the graph 40.

The visual 20j may further include a key or reference section 43 that includes the list 28a of occupations and their associated identifiers as well as the list 27a of the academic majors and their associated identifiers.

In the event that an occupation and/or an academic major are positioned at the same location within the graph 40, then, in one embodiment the respective occupation(s) and/or major(s) may be positioned at the same location, with the identifiers being slightly offset for ease of visual recognition

It should be understood that the above descriptions of visuals are not meant to be a limiting or an exhaustive description, rather an illustrative description to help the reader understand various embodiments of the invention. Further, it should be understood that text and image information displayed within a visual may be displayed in a different manner, in an enhanced manner in order to draw the text and image information to the attention of a generalized user or a given type of user. For example, certain important or priority information may be displayed in a bold typeface, in a color other than black and white, in a highlighted background, in a larger font or in conjunction with a marker of some sort, such as asterisks, exclamation points, warning/reminder symbols or warning/reminder notices, to name just a few of the many types of enhancements that may be used. As noted previously, the visuals may include audio, video, image or textual information, for example.

As was also mentioned briefly above, the platform 3 may be operable to generate a personalized user profile based on data it receives from a user device 2a. In more detail, the platform 3 may be further operable to receive a plurality of different types of user assessment data, each type associated with a different assessment (e.g., current or historical Holland code, STEM assessment data, STEAM assessment data, PGI assessment data, skills assessment data, aptitude assessment data, personality assessment data, work-related assessment data, and data from an assessment that has psychometric properties), over the communications network 4, from the device 2a.

Upon receiving such data, the platform 3 may be operable to generate assessment results for each of the different types of user assessment data, and modify one or more of the results by applying an electronic linear or non-linear weight to each result. Thereafter, the platform 3 may be operable to combine one or more of the modified (or unmodified) assessment results to form a personal assessment profile. If desired, the platform 3 may be operable to store the personal assessment profile, and transmit the personal assessment profile, over the communications network 4, to the device 2a.

The profile may be used as a screen or filter to limit (or allow as the case may be) the type of data that is ultimately communicated to the user of a device 2a. For example, in one embodiment, the device 2a may be operable to receive the profile from the platform 3, store the profile, and selectively apply the stored profile to data received from a source other than the platform 3 to identify whether, and to what extent, data within the so received data matches the profile.

Upon selectively applying the profile, the user device 2a may be yet further operable to output (e.g., display) the data that best matches features and attributes of the profile as text, audio, video or image formatted data or as a combination of such formatted data.

The description above noted that electronic weights may be applied to results. In embodiments, the weights that are applied may comprise linear or non-linear weights, and the linear or non-linear weights may comprise weights that are based on one or more attributes of users (e.g., age, nationality, employment status, health, years of education, years of employment, geographic location, gender, academic grades, academic accomplishments, skills, hobbies, vocational accomplishments, and personality properties).

While exemplary embodiments have been shown and described herein, it should be understood that variations of the disclosed embodiments may be made without departing from the spirit of the invention. For example, though the discussion above uses educational, career or vocational assessments as examples to explain the invention, it should be understood that the invention is not so limited. Other types of assessments are encompassed by the present invention. Further, while the platforms described above are depicted as being separate from user devices it should be understood that the present invention includes embodiments where a platform and user device are combined into one device or system, or alternatively, where one or more functions of a platform are included in a user device, or vice-versa. Still further, though a platform and user device may be located remotely from one another, in alternative embodiments a platform and user device may be located nearby or even co-located. In addition, it should be understood that the platforms and user devices described herein may be operable to exchange data regarding one or more of the assessments described herein in combination with other, non-assessment data, such as data that indicates a particular academic, career or vocational interest of a user that the user has originally provided to the platform or his/her device (e.g., a user already has an interest in a certain career, and skips the assessment process).

The claims that follow are intended to cover the exemplary embodiments described herein along with any equivalents of such embodiments.

1. A system for providing online assessments comprising:
a network, hardware platform operable to,
receive current or historical user assessment data;
compare the received user interest data to a plurality of stored, reference user interest reference data in real-time to determine which stored reference data matches the received user interest data;
identify one or more stored, reference academic majors that match the stored, reference user assessment data determined from the comparison in real-time; and
transmit data representing the one or more identified reference academic majors to an electronic device.

2. The system as in claim 1 wherein the user assessment data comprises current or historical user interest data.

3. (canceled)

4. The system as in claim 2 wherein the user interest data comprises current or historical Holland code associated user data.

5. The system as in claim 1 wherein the network hardware platform is further operable to identify one or more stored, reference occupations that match the stored, reference user assessment data determined from the comparison in real-time, and wherein the occupations are selected from science, technology, engineering, math and arts (STEAM) occupations.

6. The system as in claim 1 wherein the user assessment data comprises data selected from the group consisting of science, technology, engineering, math (STEM) assessment data, STEAM assessment data, personal globe inventory (PGI) assessment data, skills assessment data, aptitude assessment data, personality assessment data, work-related assessment data, and data from an assessment that has psychometric properties.

7. The system as in claim 1, wherein the electronic device comprises a wired or wireless user device, and the system further comprises such a user device operable to transmit the user assessment data to the platform.

8. The system as in claim 5 wherein the platform is further operable to:
receive confidence level and work expectation indicators for two or more of the reference academic majors, or for two or more of the occupations from the electronic device;
generate data representing a mapping of the confidence level and work expectation indicators; and
transmit data representing the mapped confidence level and work expectation indicators.

9. The system as in claim 8 wherein the platform is further operable to transmit (i) data representing at least a graphical representation of the mapped confidence level and work expectation indicators for each academic major or occupation, or (ii) data representative of the mapped confidence level and work expectation indicators for each academic major or occupation, wherein the data representative of the mapped confidence level and work expectation indicators comprises textual, audio, video or image formatted data or a combination of such formatted data, to the electronic device.

10. The system as in claim 1 wherein the platform comprises one or more hardware servers.

11. The system as in claim 1 wherein the platform is further operable to:
receive a plurality of different types of current or historical user assessment data, each type associated with a different assessment from the electronic device;
generate assessment results for each of the different types of user assessment data;
modify one or more of the results by applying an electronic linear or non-linear weight to each result;
combine one or more of the modified or unmodified assessment results to form a personal assessment profile; and
store the personal assessment profile.

12. The system as in claim 11, wherein the electronic device comprises a wired or wireless user device, and the system further comprises such a user device operable to:
receive the personal assessment profile from the platform;
store the profile; and
selectively apply the stored profile to data received from a source other than the platform to identify whether data within the so received data matches the profile.

13. The system as in claim 11 wherein the linear or non-linear electronic weights comprise weights that are based on one or more attributes of a user, the attributes selected from the group consisting of age, nationality, employment status, health, years of education, years of employment, geographic location, gender, academic grades, academic accomplishments, skills, hobbies, vocational accomplishments, and personality properties.

14. The system as in claim 5 wherein the platform is further operable to,
identify one or more academic institutions, vocational institutions or potential employers based on the identified, reference academic majors or occupations; and
transmit data representing the one or more academic institutions, vocational institutions or potential employers, to the electronic device.

15. A method for providing online assessments using a network hardware platform comprising:
receiving current or historical user assessment data at a hardware platform;
comparing the received user interest data to a plurality of stored, reference user interest reference data in real-time to determine which stored reference data matches the received user interest data;
identifying one or more stored, reference academic majors that match the stored, reference user assessment data determined from the comparison in real-time at the platform; and
transmitting data representing the one or more identified reference academic majors from the platform to an electronic device.

16. The method as in claim 15 wherein the user assessment data comprises current or historical user interest data.

17. (canceled)

18. The method as in claim 17 wherein the user interest data comprises current or historical Holland code associated user data.

19. The method as in claim 15 further comprising identifying one or more stored, reference occupations that match the stored, reference user assessment data determined from the comparison in real-time, and wherein the occupations are selected from STEAM occupations.

20. The method as in claim 15 wherein the user assessment data comprises data selected from the group consisting of STEM assessment data, science, STEAM assessment data PGI assessment data, skills assessment data, aptitude assessment data, personality assessment data, work-related assessment data, and data from an assessment that has psychometric properties.

21. The method as in claim 15, wherein the electronic device comprises a wired or wireless user device, and the method further comprises transmitting the user assessment data from the user device to the platform.

22. The method as in claim 19 further comprising:
receiving confidence level and work expectation indicators for two or more of the reference academic majors, or for two or more of the occupations from the electronic device;
generating data representing a mapping of the confidence level and work expectation indicators; and
transmitting data representing the mapped confidence level and work expectation indicators.

23. The method as in claim 22 further comprising transmitting (i) data representing at least a graphical representation of the mapped confidence level and work expectation indicators for each academic major or occupation, or (ii) data representative of the mapped confidence level and work expectation indicators for each academic major or occupation, wherein the data representative of the mapped confidence level and work expectation indicators comprises textual, audio, video or image formatted data or a combination of such formatted data, to the electronic device.

24. The method as in claim 15 further comprising:
receiving a plurality of different types of user assessment data, each type associated with a different assessment from the electronic device;
generating assessment results for each of the different types of user assessment data;
modifying one or more of the results by applying an electronic linear or non-linear weight to each result;
combining one or more of the modified or unmodified assessment results to form a personal assessment profile; and
storing the personal assessment profile.

25. The method as in claim 24 further comprising transmitting the personal assessment profile to the electronic device.

26. The method as in claim 25, wherein the electronic device comprises a wired or wireless user device, and the method further comprises:
receiving the personal assessment profile from the platform at the user device;
storing the profile at the user device; and
selectively applying the stored profile to data received from a source other than the platform at the user device to identify whether data within the so received data matches the profile.

27. The method as in claim 24 wherein the linear or non-linear electronic weights comprise weights that are based on one or more attributes of users.

28. The method as in claim 24 wherein the profile further comprises attributes of a user selected from the group consisting of age, nationality, employment status, health, years of education, years of employment, geographic location, gender, academic grades, academic accomplishments, skills, hobbies, vocational accomplishments, and personality properties.

29. The method as in claim 19 further comprising,
identifying one or more academic institutions, vocational institutions or potential employers based on the identified, reference academic majors or occupations; and
transmitting data representing the one or more academic institutions, vocational institutions or potential employers, to the electronic device.
